(19) United States
(12) Patent Application Publication
(10) Pub. No.: US 2022/0387835 A1
(43) Pub. Date: Dec. 8, 2022

(54) Quick-Burning Aerosol-Generating Fuel

(71) Applicant: Techno-TM ZAO, Moscow (RU)

(72) Inventors: Denisyuk Anatoly Petrovich, Moscow (RU); Sizov Vladimir Alexandrovich, Moscow (RU); Mikhalev Dmitry Borisovich, Moscow (RU); Shepelev Yury Germanovich, Moscow (RU); Nguyen Zui Tuan, Moscow (RU); Sidorova Yulia Alexandrovna, Moscow (RU)

(73) Assignee: Techno-TM ZAO, Moscow (RU)

(21) Appl. No.: 17/686,304

(22) Filed: Mar. 3, 2022

(30) Foreign Application Priority Data
Mar. 23, 2021 (RU) 2021107641

(51) Int. Cl. A62D 1/00

(52) U.S. Cl. CPC A62D 1/0007

(57) ABSTRACT

The fuel described contains spatially-structured fuel-binding polytetrafluoroethylene on a thermoplastic polymer base—of phenol formaldehyde resin (PFR), plasticized by dibutyl phthalate (DBP), a technological additive (calcium stearate, magnesium stearate, or a mixture of these additives), and an oxidizer—potassium nitrate or a mixture of it with potassium perchlorate in a broad ratio, a combustion catalyst—copper salicylate in individual form or in combination with carbon black, which increases its effect on the burning rate and at the same time reduces its dependence on pressure; the fuel may contain up to 25% of potassium chloride, which reduces the combustion temperature by ˜200-230 K and the content of aggressive substances of an alkaline and acidic nature, and carbon monoxide in the products of aerosol-generating fire extinguishing fuel combustion. The fuel charges are obtained with the use of rolling and continuous casting, which ensures their superior mechanical features.

### FIELD OF THE INVENTION

The invention applies to the domain of the development of quick-burning aerosol-generating fuel for various gas generators, including operational function. The fuel is composed of widely available components, possesses high fire-extinguishing capability, a burning rate that is regulated in broad intervals at atmospheric pressure (from 8 to 18 mm/s) and its low dependency on pressure in the interval up to 1-2 Megapascal (MPa) (the value of υ in the combustion rate law (U=Vr^{υ}) in the interval of 0.2-0.25).

### BACKGROUND OF THE INVENTION

One pyrotechnical aerosol-generating fire-extinguishing compound material contains a mixture of oxidants—KClO₄ with KNO₃ in a standard ratio of 3.15:1, phenol formaldehyde resin, plasticized dibutyl phthalate, polytetrafluoroethylene (PTFE), and a technological additive—calcium stearate has been used as an analog (prototype). Such prototype is described in Pyrotechnical aerosol-generating fire-extinguishing composite material and as well as the means of obtaining it. See patent number 2185865 Russian Federation by D.L. Rusin, A.P. Denisyuk, D.B. Mikhalyev, Yu.G. Shelelyev; No. 2000131491/12, filed on Dec. 15, 2000 and published on Jul. 27, 2002. The burning rate of the prototype at atmospheric pressure is 7 millimeters per second (mm/s).

The development of quick-burning aerosol-generating fuel, the burning rate of which at atmospheric pressure is substantially higher than the maximum rate of the fuel-prototype (7 mm/s) and depends less on the pressure, with an effective fire-extinguishing capability, with a controlled complex of features: e.g., temperature and compound of combustion products, physical-mechanical and technological properties making it possible to obtain charges by the method of continuous casting.

Combustion rate approaching the prototype were attained in Aerosol-generating fuel described in Russian patent number 2691353, V.P. Kolpakov, A.P. Denisyuk, Yu.G. Shepelyev, D.B. Mikhalyev, V.A. Sizov.; No. 2018122971, filed on Jun. 25, 2018 and published Jun. 11, 2019; an article by B.P. Zhukov, V.B. Zhukov, D.L. Rusin, A.P. Denisyuk, Yu.G. Shepelyev, D.B. Mikhalyev titled Low-toxic and fire-explosive fire-extinguishing fuels of Binary Technologies 1999. No. 2. P. 32 to 35; an article by A.P. Denisyuk, D.L. Rusin, Dick Long Nguyen Duc Long titled The combustion mechanism of fire extinguishing fuels on a potassium nitrate base in Academy of Sciences Papers Doklady Physical Chemistry, 2007. V. 414, No. 1-3. P. 63-6699-102; and an article by A.P. Denisyuk, D.L. Rusin, Yu.G. Shelelyev titled Highly effective aerosol-generating fire extinguishing continuous casting compounds, of Fire safety magazine in 2013. No. 2. P. 67 to 73.

It is therefor desirable to obtain a quick-burning aerosol-generating fuel, the burning rate of which at atmospheric pressure is equal to 9-18 mm/s, which is 1.4-2.6 times higher than the maximum burning rate of the prototype (7 mm/s) and is minimally dependent upon pressure—value of u≤0.25.

### SUMMARY OF THE INVENTION

A feature of the proposed fuel is that it may be obtained with the use of different basic components, distinguishable by the values α, T_{Γ}, the composition of the combustion products, including base fuels, not containing KClO₄.

The described implementation applies to the domain of the development of quick-burning aerosol-generating fuel for various gas generators, including operational function. Quick-burning aerosol-generating fuel is composed of widely available components, possesses high fire-extinguishing capability, a burning rate that is regulated in broad intervals at atmospheric pressure (from 8 to 18 mm/s), and is minimally dependent on pressure in the interval up to 1-2 MPa (the value of υ in the combustion rate law (U=Vr^{υ}) in the intervals 0.2-0.25).

The use of the proposed fuel in quick response gas generators will ensure the rapid and even fulfillment of protective volumes, including those which are air-cooled. The weak dependence of the burning rate on pressure in accident situations will significantly reduce the possibility of a sharp increase in pressure and the transition of the combustion into an explosion.

In addition, the high burning rate allows for the use of an end burning charge, which ensures the higher density of generator loading, the optimization of its design, in particular, to reduce its mass and dimensions, which is especially important for portable disposable generators.

The fuel contains spatially-structured fuel-binding polytetrafluoroethylene on a thermoplastic polymer base—of phenol formaldehyde resin (PFR), plasticized by dibutyl phthalate (DBP), a technological additive (calcium stearate, magnesium stearate, or a mixture of these additives), an oxidizer—potassium nitrate or a mixture of it with potassium perchlorate in a broad ratio (the potassium perchlorate share is 0.2-0.5%), and a combustion catalyst—copper salicylate in individual form or in combination with carbon black, which increases its effect on the burning rate and at the same time reduces its dependence on pressure. The fuel may contain up to 25% of potassium chloride, which reduces the combustion temperature by ˜200-230 K and the content of aggressive substances of an alkaline and acidic nature, and carbon monoxide in the products of aerosol-generating fire extinguishing fuel combustion.

The fuel charges are obtained with the use of rolling and continuous casting, which ensures their superior mechanical features.

### DETAILED DESCRIPTION OF PREFERRED EMBODIMENTS

### Embodiment 1

In the base fuel, into which the combustion catalyst or its mixture with carbon black or carbon nanotubes, the ratio between phenol formaldehyde resin (PFR) and dibutyl phthalate (DBP) should be within the range of 1.7 to 4. This ensures the increased combustion rate of the basic compound and expands the possibility of increasing it by introducing a different amount of the catalyst (up to ˜2%) or of a mixture of it with carbon materials (up to ˜4%).

A drop in the combustion temperature of the quick-burning fuel and of the content in the combustion products of substances of an alkaline nature and CO is achieved by the introduction of calcium chloride into its composition.

The technological and physical-mechanical features of the fuel with a varied content of additives and at a varied ratio of the quantity of PFR and DBP are regulated by polytetrafluoroethylene in a quantity of 1-2%.

The indicated result is attained by means of the introduction of a combustion catalyst (basic copper salicylate) in individual form or in combination with carbon black or carbon nanotubes into an aerosol-generated fuel for volumetric fire extinguishing, which contains oxidants and bonds PFR plasticized by dibutyl phthalate in a ratio of >1.5; polytetrafluoroethylene and a technological additive, and the indicated bond in which the PFR and DBP ratio lies within the range of 1.7-4. This ratio plays an important role in the development of a high burning rate of fuels.

As described in A.P. Denisyuk, D.L. Rusin, Nguyen Duc Long, the combustion mechanism of fire extinguishing fuels on a potassium nitrate base, Doklady Physical Chemistry. 2007. V. 414, No. 1-3. P. 99-102, the contents of which are hereby incorporated by reference, it was demonstrated that fuel combustion based on PFR, comparatively plasticized by highly volatile plasticizers (DBP, dioctyl sebacate (DOS) and the like), and potassium nitrate (alone or in combination with potassium perchlorate), a basic amount of heat (more than 80%) necessary for spreading combustion is separated in the reaction layer of the k-phase. Such separation is a result of the direct interaction of decomposed potassium nitrate with the products of PFR disintegration, and the plasticizers partially vaporize from the k-phase and react in the gas zone with the remaining oxygen. The heat release in this zone has little effect on the rate of combustion. If there is an increased DBP content in the fuel, in its vaporization the contents of the products of PFR disintegration decrease, so that due to its relatively small content in the k-phase, the heat release in the k-phase decreases and, accordingly, the burning rate decreases. For this reason, the burning rate of the base fuel (without a catalyst) depends upon the correlation between the amount of PFR and the amount of the plasticizers (indicated by β value) given the equivalent (similar) content of the bond in the fuel, (i.e. given similar α values). This is evident from table 1: the minimum fuel burning rate (4.4 mm/s) corresponds to the low β value (1.44), and at β=3 and 4 the rate is substantially higher (by 1.81 and double, correspondingly).

Thus, it is not only the amount of the catalyst which defines the amount of the burning rate of fuel, but also the ratio between the PFR and the DBP content. It is on this principle that quick-burning fuels are created. The wide interval with the β value is dependent upon the difference in the composition of fuels (the content of additives, their nature), which is reflected in their technological and mechanical characteristics. To lower the combustion temperature and the quantity of hazardous substances of an alkaline and acidic nature, as well as CO, potassium chloride is introduced into the composition of fuel combustion products as described in Aerosol-generating fuel: Russian patent number 2691353 by V.P. Kolpakov, A.P. Denisyuk, Yu.G. Shepelyev, D.B. Mikhalyev, V.A. Sizov.;No. 2018122971 that was filed on Jun. 25, 2018 and published Jun. 11, 2019. the content of which is hereby incorporated by reference.

Fuel contains potassium nitrate or its mixture with potassium perchlorate up to a 78 weight % in a ratio of 0.2-0.5 as an oxidizer.

The content of components in fuel is (mass %):

| | |
|---|---|
| PFR | 7.4-15.6 |
| DBP | 4.3-8 |
| in a PFR:DBP ratio, | 1.7-4 |
| Basic copper salicylate | up to 2% |
| PTFE | up to 2% |
| Calcium stearate or zinc | 0.5% |
| Carbon black or carbon nanotubes | up to 2% |
| Potassium chloride (KCl) | up to 25% |
| KNO₃ or its mixture with KClO₄ | the remaining amount |

In one implementation, the mixture goes through rolling at 70-85° C., with the resulting canvas being put under pressure through passing, to mold and to get form at 70-80° C.

The proposed fuel differs from the prior described prototype chiefly in the following characteristics:

1. In the use in fuel of a catalyst—copper salicylate, including in combination with carbon black, which increases the effect of the catalyst on the burning rate and reduces its dependence upon pressure in the interval of 0.1-2 MPa (value of υ˜0.2), and for certain components in the interval of 0.1-18 MPa.

We note that in the fuel-prototype, as described in Pyrotechnical aerosol-generating fire-extinguishing composite material and the means of obtaining it: Russian patent number 2185865 by D.L. Rusin, A.P. Denisyuk, D.B.Mikhalyev, Yu.G. Shelelyev; No. 2000131491/12; filed on Dec. 15, 2000 and published Jul. 27, 2002, carbon black is added in a minimal amount (≤0.1%) to ensure the surface layers of fuels charges from the effect of the action of light, which causes the fuel to redden Using in this amount (≤0.1%), the carbon black neither changes the characteristics of fuels, nor does it increase the effectiveness of catalyst action.

2. The essential condition for obtaining a quick-burning fuel is the specific ratio between the polymer (PFR) and the plasticizer (DBP), which lies in the interval of 1.7-4. This factor plays an important role in the achievement of a high burning rate.

3. Fuel may contain up to 25% of KCl to reduce the combustion temperature and the content of ecologically harmful gasses (CO) in combustion products and substances of an alkaline and acidic nature. The use of KCl will reduce the cost of fuels.

4. The proposed fuel will allow for the use of end burning charges, which will increase the density of the charge in gas generators.

5. The proposed quick-burning fuel with a high fire emission capability will ensure a more effective extinguishing of fires in air-cooled buildings.

Let us now review the complex of properties of the samples of proposed quick-burning aerosol-generating fuels: the fire-extinguishing capability, burning rate (R_{b}), its dependence upon pressure, and its physical-mechanical and technological characteristics.

Samples of aerosol-generating fuels for their experiments were obtained in the following way:

a suspension of PFR is prepared in methylene chloride or carbon tetrachloride (the ratio of PFR with a solvent is ˜6:1) to this ensures a safe mixture and eliminates dust from powder-generating components;

to the resulting suspension is stirred in a dispersion of PTFE in dibutyl phthalate in a ratio of 1:1.2;

into the resulting mixture, they added portions of oxidizers (KClO₄, KNO₃), carbon black, a catalyst, a technological additive (potassium stearate, magnesium, etc.), potassium chloride;

they exposed the mixture to the thermomechanical action of rolling at a temperature of 70-90° C. and a roller rotational speed (diameter of 100 mm) of 5 to 10 rpm. During the rolling, the oxidizer disintegrates and is evenly distributed throughout the fuel-bonding space, and the further plasticizing of PFR occurs, which ensures the optimal viscous flow characteristics of the fuel-bond and the entire fuel mass. The rolling yielded a high-grade material, which is put into a casting press at 70-85° C. and then continuously casted at a temperature of 80-90° C.

The burning rate of the samples are set at atmospheric pressure at aerosol-generating fuel charges of d˜7 mm, with a precisely measured height (h=15-20 mm), armored along the lateral surface. The combustion time of the charges are determined with a high-speed CASIO Exilim EX-F1 camera with a filming frequency of 300, 600, or 1200 frames per second (fps). The dependency of the burning rate on pressure is determined in a full pressure regulator (FPR) in a nitrogen atmosphere. This dependency is expressed by means of a power law R_{b}=Apⁿ. The less the value v, the less the pressure in the gas generator depends upon the measurement of the charging parameters (T₀, the combustion surface, the area of intersection of the exit openings and the like).

They determined the fire-extinguishing capability in a hermetic cabinet with a volume of V_{c}=300 liters, in which a system for igniting the model and a fan were placed. Externally on a transparent door, a pull-out table with a burner was placed.

The burner—an “alcohol stove” was used to imitate a fire source (wick d=˜5 mm) using isopropane. After lighting the model, they blended the aerosol over 30 seconds with two seven-bladed fans with a diameter of 80 mm (q=95 M³/h). After disconnecting them, using the pull-out table, they placed the burner with the isopropane into the cabinet and set the time (t) for putting out the flame using a second meter.

If one took the mass of the model to be consumed m* as the characteristic of the fire extinguishing capability (g/M³), for which the characteristic for the relationship lnt(m), with respect to a unit of the protected volume then fire extinguishing capability =m*/V_{c}.

To obtain high-quality products in the casting of charges of a given type by the continuous casting method, the molded material should have a value K_{T} in an interval from 2 to 5.

TABLE 1
Effect of PFR-plasticizer ratios on the characteristics of fuel

| Composition, % | 1 | 2 | 3 | 4 |
|---|---|---|---|---|
| KNO₃, % | 78.5 | 78.5 | 78.5 | 78.5 |
| PFR, % | 11.5 | 11.7 | 14.6 | 15.6 |
| DBP, % | 8.0 | 7.8 | 4.9 | 3.9 |
| PTFE, % | 1.5 | 1.5 | 1.5 | 1.5 |
| Calcium stearate, % | 0.5 | 0.5 | 0.5 | 0.5 |
| Oxidizer excess ratio (α) | 0.72 | 0.72 | 0.71 | 0.71 |
| T, K | 1518 | 1516 | 1506 | 1506 |
| PFR to DBP ( ) | 1.44 | 1.5 | 3 | 4.0 |
| Average R_{b} at 0.1 | 4.4 | 5.0 | 8.0 | 8.6 |
| Mpa,, mm/s | | | | |
| Fire-extinguishing | 12.3 | 12 | 11 | 10.2 |
| capability, g/M³ | | | | |

From Table 1 with the increase of β from 1.44 to 4 the burning rate of the base samples with the identical value α and T_{g} increases almost twofold. Moreover, the fire-extinguishing capability improves somewhat—its value declines from 12.3 to 10.2 g/M³.

### Embodiment 2

TABLE 2
Effect of the catalyst with carbon black
on the characteristics of the base fuel

| Composition, % | 5 | 6 | 7 |
|---|---|---|---|
| KClO₄% | 19.9 | 19.6 | 19.6 |
| KNO₃, % | 62.8 | 62.0 | 62.0 |
| PFR, % | 9.4 | 9.3 | 10.4 |
| DBP, % | 5.5 | 5.4 | 4.4 |
| PTFE, % | 1.9 | 1.9 | 1.9 |
| Calcium stearate, % | 0.5 | 0.5 | 0.5 |
| Copper salicylate, % | — | 1 | 1 |
| Carbon black, % | — | 0.3 | 0.3 |
| α | 0.943 | 0.913 | 0.905 |
| T, K | 1840 | 1765 | 1754 |
| β | 1.7 | 1.7 | 2.4 |
| R_{b}, 0.1 av, mm/s | 4.7 | 7.8 | 13 |
| Fire-extinguishing | 11.6 | 10 | 7.6 |
| capability, g/M³ | | | |

From Table 2 model No. 7 with the highest β value=2.4 has the highest burning rate (13 mm/s); model No. 6 with the same amount of catalyst, but with a β=1.7 burns˜1.7 times slower, and model No. 5 without a composite catalyst ˜2.8 times.

It is very important that high-speed samples with a composite catalyst have a much better fire-extinguishing capability than the base model. Thus, for model No. 7 (u=13 mm/s) the fire extinguishing capability value (7.6 g/m³) is ˜1.6 less than that of base fuel (11.6 g/m³).

### Embodiment 3

Table 3 presents aerosol-generating fire-extinguishing compound samples (No. 8-13), containing copper salicylate in the quantity of 1.2% with a different carbon black content (0-0.5%).

TABLE 3
Quick-burning aerosol-generating fuels, containing 1.2-1.7% of composite catalyst

| Composition, % | 8 | 9 | 10 | 11 | 12 | 13 |
|---|---|---|---|---|---|---|
| KClO₄, % | 27.5 | 27.5 | 27.5 | 27.5 | 27.5 | 27.5 |
| KNO₃, % | 49.1 | 49.1 | 49.1 | 49.1 | 49.1 | 49.1 |
| PF, % | 14.4 | 14.4 | 14.1 | 14.4 | 14.4 | 14.8 |
| DBP, % | 5.3 | 5.3 | 5.6 | 5.3 | 5.3 | 4.9 |
| F-4, % | 2 | 2 | 2 | 1.8 | 1.6 | 1.8 |
| Calcium stearate, % | 0.5 | 0.4 | 0.4 | 0.4 | 0.4 | 0.4 |
| Copper salicylate, % | 1.2 | 1.2 | 1.2 | 1.2 | 1.2 | 1.2 |
| Carbon black, % | 0 | 0.1 | 0.1 | 0.3 | 0.5 | 0.3 |
| α | 0.71 | 0.71 | 0.71 | 0.70 | 0.70 | 0.70 |
| T, K | 1544 | 1544 | 1545 | 1538 | 1535 | 1540 |
| β | 2.7 | 2.7 | 2.5 | 2.7 | 2.7 | 3.0 |
| R_{b}, 0.1 av, mm/s | 15.2 | 15.9 | 15.4 | 16 | 17.2 | 18 |
| Fire-extinguishing capability, g/M³ | 9.9 | 9.9 | 9.5 | 9.7 | 9.6 | 9.5 |

From Table 3 it is evident that if β=2.5-3, the burning rate and the fire-extinguishing capability differ insignificantly, that the high reproducibility of the properties of the different batches of fuel charges should be ensured. Moreover, we note that model No. 8 without carbon black burns somewhat slower (15.2 mm/s), than with 0.3 and 0.5% carbon black (17.2 and 18 mm/s, respectively).

### EmbodimenT 4

Table 4 presents aerosol-generating fire extinguishing compound samples (No. 14-16) one of which is without KCl, while two are with KCl in the quantity of 19% and 25%, which are incorporated due to the proportional reduction of all components. This addition dropped the combustion temperature to ˜190 and 230 K, practically does not change the fire-extinguishing capability, and only weakly reduces the burning rate (u_{0.1}=12 and 11 mm/s, respectively; without KCl u_{0.1}=13 mm/s). We note that for the samples with KCl the quantity of substances of an alkaline nature (K and KOH) in the combustion products is substantially reduced—by 2.5 and 4.4 times.

TABLE 4
Quick-burning aerosol-generating fuels containing KCl

| Composition, % | 14 | 15 | 16 |
|---|---|---|---|
| KClO₄% | 29.4 | 23.7 | 21.8 |
| KNO₃, % | 49.1 | 39.5 | 36.2 |
| PFR, % | 11.8 | 9.5 | 8.6 |
| DBP, % | 5.7 | 4.7 | 4.3 |
| PTFE, % | 1.9 | 1.6 | 1.6 |
| Calcium stearate, % | 0.5 | 0.4 | 0.4 |
| Copper salicylate, % | 1.3 | 1.3 | 1.8 |
| Carbon black, % | 0.3 | 0.3 | 0.3 |
| KCl, % | — | 19 | 25 |
| α | 0.788 | 0.788 | 0.787 |
| T, K | 1719 | 1530 | 1487 |
| β | 2.1 | 2.0 | 2.0 |
| R_{b}, 0.1 av, mm/s | 13 | 12 | 11 |
| Fire-extinguishing | 9 | 10 | 11 |
| capability, g/M³ | | | |
| CO, mol/kg | 5.405 | 4.531 | 4.247 |
| CO₂ mol/kg | 6.449 | 4.396 | 3.881 |
| K, mol/kg | 1.379 | 0.438 | 0.235 |
| KOH, mol/kg | 2.677 | 1.183 | 0.692 |

In all the samples, the ratio between KNO₃ and KClO₄ is equal to 1.66; i.e., it is significantly less than in the model taken as the prototype (Table 1, model No. 1), for which this ratio is ≥3.15. We emphasize that the ratio of PFR to DBP is higher (˜2), than for the prototype (˜1.7).

From Table 4 it is evident that all the samples have a high burning rate and a high extinguishing capability. This is caused not only by the effect of the catalyst, but also by the increase in the ratio of PFR to DBP. The addition of KCl somewhat (by ˜15%) reduces the combustion temperature and the number of substances of an alkaline nature in combustion products (by 2-4 times).

### Embodiment 5

Table 5 shows 5 aerosol-generating fire-extinguishing compound samples with a high β value (2.7) (Nos. 16-18), containing 1.2% of copper salicylate, distinguished by carbon black content in the compound (0-0.5%). When the carbon black content is increased, the burning rate increases from 15 to 18 mm/s, while the value of the fire-extinguishing capability is ˜10 g/m³.

TABLE 5
Quick-burning aerosol-generating fuels containing
a different amount of carbon black

| Composition, % | 17 | 18 | 19 |
|---|---|---|---|
| KClO₄% | 27.5 | 27.5 | 27.5 |
| KNO₃, % | 49.1 | 49.1 | 49.1 |
| PFR, % | 14.4 | 14.4 | 14.4 |
| DBP, % | 5.3 | 5.3 | 5.3 |
| PTFE, % | 2 | 1.8 | 1.6 |
| Calcium stearate, % | 0.5 | 0.4 | 0.4 |
| Copper salicylate, % | 1.2 | 1.2 | 1.2 |
| Carbon black, % | 0 | 0.3 | 0.5 |
| A | 0.71 | 0.70 | 0.70 |
| T, K | 1544 | 1538 | 1535 |
| PF/DBP | 2.7 | 2.7 | 2.7 |
| R_{b} 0.1 av, mm/s | 15.9 | 16.5 | 17.9 |
| Fire-extinguishing | 9.9 | 9.7 | 9.6 |
| capability, g/M³ | | | |

### Embodiment 6

Table 6 shows aerosol-generating fire-extinguishing compound samples on an oxidant base KNO₃, with a constant value of β=1.5; containing an increased amount of the catalyst copper salicylate (1.9%) both in individual form and in combination with a varied amount (1-1.9%) of carbon black and Taunit-MD (T-MD) carbon nanotubes. With the addition of the carbon nanotubes a higher burning rate is ensured from 7.5 to 8.5-9.2 mm/s, and the value of the fire-extinguishing capacity is reduced from 11.7 to 10.7.

TABLE 6
Quick-burning aerosol-generating fuel on a potassium nitrate base,
containing a catalyst with carbon black or carbon nanotubes

| Composition, % | 20 | 21 | 22 | 23 | 24 |
|---|---|---|---|---|---|
| KNO₃, % | 77 | 76.2 | 75.5 | 76.2 | 75.5 |
| PFR. % | 11.4 | 11.4 | 11.3 | 11.4 | 11.3 |
| DBP, % | 7.6 | 7.6 | 7.5 | 7.6 | 7.5 |
| PTFE, % | 1.5 | 1.5 | 1.4 | 1.5 | 1.4 |
| Calcium stearate, % | 0.5 | 0.5 | 0.5 | 0.5 | 0.5 |
| Copper salicylate, % | 1.9 | 1.9 | 1.9 | 1.9 | 1.9 |
| carbon black, % | — | 1 | 1.9 | — | — |
| T-MD carbon | — | — | — | 1 | 1.9 |
| nanotubes, % | | | | | |
| A | 0.70 | 0.67 | 0.65 | 0.67 | 0.65 |
| T, K | 1504 | 1477 | 1446 | 1477 | 1446 |
| PF/DBP | 1.5 | 1.5 | 1.5 | 1.5 | 1.5 |
| R_{b}, 0.1 av, mm/s | 7.5 | 7.7 | 8.2 | 8.5 | 9.2 |
| Fire-extinguishing | 11.7 | 11.5 | 11.3 | 11.0 | 10.7 |
| capability, g/M³ | | | | | |

It is also important that the proposed fuels may be used in gas generators which operate at pressure that is higher than atmospheric pressure, for example, within the range of 0.1-1 MPa, at which the rate weakly depends upon pressure (the value u in the combustion law R_{b}=Apⁿ is ≤0.25). This should ensure the high uniformity of operation of the gas generator when the initial temperature of charges changes, for example, from −50 to +150° C.

It will increase the safety of production, implementation, and the protection of charges and gas generators.

The studied fuels possess high mechanical qualities: shear strength (σᵣ) at 20° C. equal to 2.9-3.5 MPa with a deformation ˜25-30%. The technological properties of the presented samples (technology coefficient C_{T}˜3-4) makes it possible to obtain charges by the continuous casting method.

The present composition for extinguishing fires and the process for its preparation allow to effectively extinguish fires of different burning materials in buildings and devices such as: warehouses, garages, working places;

offices, places for keeping animals and birds;
motor and luggage sections of transport media;
ventilator systems of production plants, hotels, etc.

The advantages of the present composition and process for its preparation are the following:

1) Ease and safety of the preparation process, 2) durability and reliability during use, 3) high fire-extinguishing efficiency, 4) a broad base of raw materials for the components of the composition and the possibility to use easily available equipment for the performance of the preparation process, 5) low pressure for molding an article from the composition, 6) low combustion temperature, furthermore, 7) the fire-extinguishing, gas-aerosol mixture does not show an injurious effect on human beings and living organisms surrounding them, the nature, and high-precision devices and systems.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion but should be defined by the appended claims.

What is claimed is:

1. A process for the preparation of a pyrotechnical, aerosol-forming composition for extinguishing fires, comprising:
providing at least one of potassium nitrate (KNO₃) or a mixture of potassium nitrate with potassium perchlorate (KClO₄) as an oxidizer;
mixing with the oxidizer a powdery combustible binder, which is a polycondensate of formaldehyde resin (PFR), plasticized by dibutyl phthalate (DBP), in a ratio of PFR:DBP from 1.7 to 4; and
adding to the mix of the oxidizer a powdery combustible binder a polytetrafluoroethylene (PTFE), at least one of Calcium stearate or zinc as a technical additive, a potassium chloride (KCl) as a multifunctional filler, and a basic copper salicylate as a burning rate modifier in combination with at least one of carbon black or carbon nanotubes, wherein mass % of the components are:

| | |
|---|---|
| PFR | 7.4-15.6% |
| DBP | 4.3-8% |
| Basic copper salicylate | up to 2% |
| PTFE | up to 2% |
| Calcium stearate or zinc | 0.5% |
| Carbon black or carbon nanotubes | up to 2% |
| KCl | up to 25% |
| KNO₃ or its mixture (in combination) with KClO₄ | remaining |
| | amount |

2. The process as recited in claim 1 further comprising adding a burning rate modifier the mix to reduce dependence of the composition upon pressure in the interval of 0.1-2 MPa, value of n=0.2-0.4.

3. The process as recited in claim 1, wherein the combination KNO₃ is added with KClO₄ at a ratio by weight of 49.1 to 27.5.

4. The process as recited in claim 1, wherein the potassium nitrate is combined with the potassium perchlorate in a ratio of 0.2-0.5.

5. The process as recited in claim 1, wherein the mass percentage of potassium nitrate or in combination with potassium perchlorate is up to 78%.

6. The process as recited in claim 1, wherein the mass percentage of KNO₃ is between 49% and 5%.

7. The process as recited in claim 1, wherein the mass percentage of KClO₄ is between 19.6% and 29.4%.

8. The process as recited in claim 1, wherein the mass percentage of KClO₄ is between 8.6%. and 19.3%.

9. The process as recited in claim 1, wherein the mass percentage of Basic copper salicylate is between .5%. and 1.9%.

10. The process as recited in claim 1, wherein the mass percentage of PTFE is between 1.4%. and 2%.

11. The process as recited in claim 10, wherein the mass percentage of PTFE is between 1.4%. and 2%, the mass percentage of Basic copper salicylate is between .5%. and 1.9%, the mass percentage of Carbon black or carbon nanotubes is between .1%. and 2.%, and KCL is at least 15%.
